(19) United States
(12) Patent Application Publication
(10) Pub. No.: US 2025/0030511 A1
(43) Pub. Date: Jan. 23, 2025

(54) POSITIONING USING REFERENCE SIGNALS WITH OVERLAPPING RESOURCES BETWEEN ADJACENT FREQUENCY HOPS

(71) Applicant: ZTE Corporation, Shenzhen (CN)

(72) Inventors: Chuangxin JIANG, Shenzhen (CN); Zhaohua LU, Shenzhen (CN); Guozeng ZHENG, Shenzhen (CN); Focai PENG, Shenzhen (CN); Yu PAN, Shenzhen (CN); Qi YANG, Shenzhen (CN); Juan LIU, Shenzhen (CN)

(73) Assignee: ZTE Corporation, Shenzhen (CN)

(21) Appl. No.: 18/737,524

(22) Filed: Jun. 7, 2024

Related U.S. Application Data
(63) Continuation of application No. PCT/CN2022/072990, filed on Jan. 20, 2022.

(51) Int. Cl. H04L 5/00

(52) U.S. Cl. CPC H04L 5/0012; H04L 5/0048

(57) ABSTRACT

Presented are systems, methods, apparatuses, or computer-readable media for positioning wireless communication devices. A wireless communication device may receive, from a wireless communication node, a configuration of an association between a first positioning reference signal (PRS) at a first frequency hop in a first time and a second PRS at a second frequency hop in a second time. The wireless communication device may communicate, with the wireless communication node, a capability of the wireless communication device to support the association between the first frequency hop and the second frequency hop. A total bandwidth of the first frequency hop and second frequency hop may be larger than a capability of the wireless communication device to support communication at a time.

### CROSS-REFERENCE TO RELATED APPLICATION

This application claims the benefit of priority under 35 U.S.C. § 120 as a continuation of International Patent Application No. PCT/CN2022/072990, filed on Jan. 20, 2022, the disclosure of which is incorporated herein by reference in its entirety.

### TECHNICAL FIELD

The disclosure relates generally to wireless communications, including but not limited to systems and methods for positioning of wireless communication devices.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, a method, an apparatus, or a computer-readable medium for positioning wireless communication devices. A wireless communication device may receive, from a wireless communication node, a configuration of an association between a first positioning reference signal (PRS) at a first frequency hop in a first time and a second PRS at a second frequency hop in a second time. The wireless communication device may communicate, with the wireless communication node, a capability of the wireless communication device to support the association between the first frequency hop and the second frequency hop. A total bandwidth of the first frequency hop and second frequency hop may be larger than a capability of the wireless communication device to support communication at a time.

In some embodiments, the association between the first PRS and the second PRS may be defined as a frequency overlap between the first PRS and the second PRS. In some embodiments, a start frequency of the second PRS may correspond to an end frequency of the first PRS shifted by the frequency overlap. In some embodiments, the frequency overlap between the first PRS and the second PRS may be determined based at least on one of: a bandwidth for the first frequency hop or the second frequency hop; a center frequency; a number of frequency hops; or a subcarrier spacing.

In some embodiments, an end frequency of the second PRS may correspond to a start frequency of the first PRS shifted by the frequency overlap. In some embodiments, the wireless communication device or the wireless communication node may report one or more hop information for a location measurement result. In some embodiments, an overlapping portion between the first PRS and the second PRS defined by the association may include a plurality of resource blocks in a non-staggered pattern. A non-overlapping portion of the first PRS or the second PRS may be a staggered pattern.

In some embodiments, the first PRS or the second PRS in the non-staggered pattern among the plurality of resource blocks may be located at one of each M subcarriers. M may be an integer value equaling to or larger than 1. In some embodiments, M value may be determined by at least one of: a bandwidth for the first frequency hop or the second frequency hop; a center frequency; a number of frequency hops; a subcarrier spacing; or frequency density in one symbol of a non-overlapping part. In some embodiments, an overlapping portion between the first PRS and the second PRS may include at least one switching gap. The a size of the switching gap may be dependent on the subcarrier spacing (SCS) or the capability of the wireless communication device.

In some embodiments, a start frequency of the first frequency hop and a start frequency of the second frequency hop may be independently configurable. In some embodiments, at least some adjacent symbols in each frequency hop of an overlapping portion may include a same sequence value. In some embodiments, the sequence value of a first subset of resource elements for a first symbol in each frequency hop of an overlapping portion may be generated based at least on sequence value of the first subset of resource elements for a second symbol. In some embodiments, the sequence value of a second subset of resource elements for the second symbol in each frequency hop of an overlapping portion may be generated based at least on sequence value of the second subset of resource elements for the first symbol, and first subset and the second subset are not overlapping in frequency domain.

In some embodiments, an overlapping portion between the first PRS and the second PRS defined by a frequency overlap may be a first type of PRS different from a second type of a remaining portion of at least one of the first PRS or the second PRS. In some embodiments, both the first type of the first PRS and second type of the second PRS may be for positioning. In some embodiments, the capability of the wireless communication device may include the first type of PRS in the overlapping portion.

In some embodiments, the configuration may include a linkage among two resource groups which correspond to the first PRS and the second PRS respectively. In some embodiments, a measurement result may be determined based at least on combination of the resources of the two resource groups. In some embodiments, a resource group may include at least one of: a PRS resource, a PRS resource set, a PRS positioning frequency layer (PFL), a bandwidth part (BWP), or a component carrier (CC) of a serving cell. In some embodiments, a measurement result may include the information of one or more resources in the linked resource groups. The information of one resource may refer to the measurement result based at least on single frequency hop PRS.

In some embodiments, a third signal different from the first PRS and the second PRS may be associated with a frequency of one of the first PRS or the second PRS. In some embodiments, the capability of the wireless communication device may include a maximum number Fₕ of supported frequency hops or linked resource groups. In some embodiments, the capability of the wireless communication device may include a duration Nₕ of reference signal symbols to processed over a time period Tₕ for a bandwidth Bₕ or a number F of supported frequency hops or linked resource groups. In some embodiments, the capability of the wireless communication device may include a maximum number of reference signal resources Rₕ processed in a slot for a frequency hopping measurement.

In some embodiments, at least one of following is satisfied:

$$\frac{{N}_{h}}{{T}_{h}} < \frac{N}{T} , or \qquad ( 1 )$$

$${R}_{h} < R , \qquad ( 2 )$$

The capability of the wireless communication device may include a duration N of PRS symbols to processed over a time period T for a bandwidth B when no frequency hopping is enabled, and R may be maximum number of references signal resources processed in a slot for a non-frequency hopping measurement.

In some embodiments, at least one of Nₙ, Tₕ, and Rₕ may be determined based at least on one of R, N, T and F. In some embodiments, for the purpose of DL PRS processing capability, the duration K of DL PRS symbols may include a switching gap between the first PRS and the second PRS. In some embodiments, for the purpose of DL PRS processing capability, the duration K of DL PRS symbols may be determined based on at least one of: enablement of reference signal frequency hopping, a number of reference signal frequency hops, or the total bandwidth of the first frequency hop and the second frequency hop.

In some embodiments, the configuration may include a prioritization of the first frequency hop or the second frequency hop for measurement in an radio resource control (RRC) inactive state or idle state. In some embodiments, a single measurement report may be based on one of the first or second PRS in an radio resource control (RRC) inactive state or idle state. In some embodiments, the capability of the wireless communication device may include at least one of support of frequency hopping or a maximum number of supported frequency hops for RRC connected state and at least one of support of frequency hopping or maximum number of supported frequency hops for RRC inactive state.

At least one aspect is directed to a system, a method, an apparatus, or a computer-readable medium for positioning wireless communication devices. A wireless communication node may send, to a wireless communication device, a configuration of an association between a first positioning reference signal (PRS) at a first frequency hop and a second PRS at a second frequency hop to be transmitted by the wireless communication device. The wireless communication node may receive, from the wireless communication node, a capability of the wireless communication device to support the association between the first frequency hop and the second frequency hop. A total bandwidth of the first frequency hop and second frequency hop may be larger than a capability of the wireless communication device to support communication at a time.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a diagram of resource mapping patterns for positioning reference signal (PRS) patterns in accordance with an illustrative embodiment;

FIG. 4 illustrates a block diagram of a frequency hopping of positioning sounding reference signal (SRS) within a single resource in accordance with an illustrative embodiment;

FIG. 5A illustrates a block diagram of a frequency hopping of positioning sounding reference signal (SRS) within a single resource with overlapping resource blocks in which a start frequency of a first frequency hop corresponds to an end frequency of a second frequency hop, in accordance with an illustrative embodiment;

FIG. 5B illustrates a block diagram of a frequency hopping of positioning sounding reference signal (SRS) within a single resource with overlapping resource blocks in which an end frequency of a first frequency hop corresponds to a start frequency of a second frequency hop, in accordance with an illustrative embodiment;

FIG. 6A illustrates a block diagram of a non-staggered pattern in overlapping physical resource blocks (PRBs) in adjacent frequency hops of positioning reference signals (PRS) in accordance with an illustrative embodiment;

FIG. 6B illustrates a block diagram of a non-staggered pattern in overlapping physical resource blocks (PRBs) of various frequency densities in accordance with an illustrative embodiment;

FIG. 6C illustrates a block diagram of a frequency hopping of positioning sounding reference signal (SRS) within a single resource with non-staggered pattern in the overlapping physical resource blocks (PRBs), in accordance with an illustrative embodiment;

FIG. 6D illustrates a block diagram of setting of sequence values in an overlapping portion of the physical resource blocks (PRBs) for positioning sounding reference signals (SRS) in adjacent frequency hops, in accordance with an illustrative embodiment;

FIG. 6E illustrates a block diagram of a sequence design for an overlapping portion of the physical resource blocks (PRBs) for positioning sounding reference signals (SRS) in adjacent frequency hops, in accordance with an illustrative embodiment;

FIG. 7 illustrates a block diagram of a frequency hopping of positioning sounding reference signal (SRS) within a single resource with overlapping resource blocks of a set frequency density and hopping gap, in accordance with an illustrative embodiment;

FIG. 8 illustrates a block diagram of a linkage between two resource groups in positioning sounding reference signals in adjacent frequency hops, in accordance with an illustrative embodiment; and

FIG. 9 illustrates a flow diagram of a method of positioning of wireless communication devices in accordance with illustrative embodiment.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 1. Mobile Communication Technology and Environment

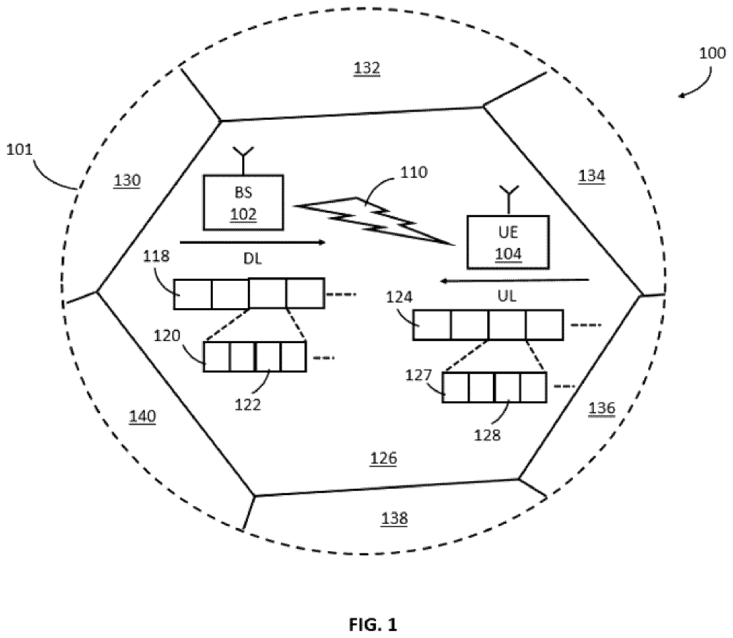

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

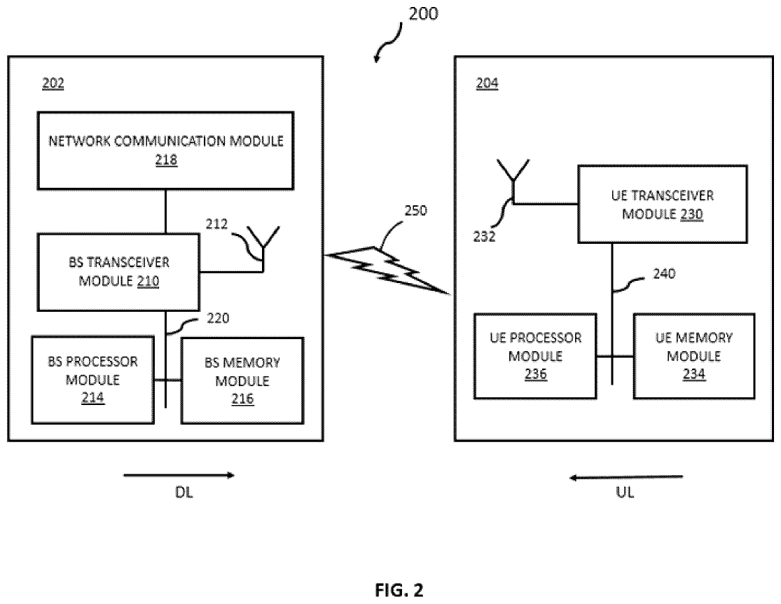

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

### 2. Systems and Methods for Positioning of Wireless Communication Devices

For timing based positioning methods, the positioning accuracy may be highly reliant on positioning reference signal (PRS) bandwidth. However, for low cost UEs, the support maximum bandwidth may be limited. For example, a reduced capability (RedCap) UEs can only support 20 MHz in FR1 and 100 MHz in FR2. Achieving high positioning accuracy and keep low cost for this kind of UEs may be unclear. The present disclosure details supporting PRS frequency hopping with K physical resource block (PRB) overlapping between adjacent frequency hops for the sake of equivalent large bandwidth PRS and mitigating phase noise impact.

Positioning service may be used \in outdoor or indoor. In outdoor scenarios, GPS can be used for positioning. In indoor scenarios, GPS signal power may be too weak to get accurate positioning estimation. In such scenarios, wireless dependent positioning solutions can be used, such as timing difference based positioning techniques. However, positioning reference signal may only be transmitted within limited bandwidth, thereby causing accuracy limitation especially for UEs with low cost which only support small bandwidth at a given time.

A. Positioning Reference Signals with Overlapping Resources in Adjacent Frequency Hops

Radio access technology (RAT)-dependent positioning methods may include Multi-cell round trip time (RTT), a time difference on arrival (TDOA), angle of arrival (AoA), or angle of departure (AoD) based positioning methods, among others. For a downlink (DL) measurement, multiple transmit/reception points (TRPs) may transmit positioning reference signals (e.g., DL-PRS), and UE may measure and obtain the measurement results for different positioning methods. Then, a location management function (LMF) or UE can calculate UE location based on the measurement results. The measurement results may include arrive time difference between the UE to multiple TRPs, a reference signal received power (RSRP), and UE Rx-Tx time difference, among others. For uplink (UL) measurement, UE can transmit a sounding reference signal (SRS) or SRS for positioning (UL-PRS or positioning SRS) to multiple TRPs, and TRPs can measure and obtain the UL measurement results. Then, the LMF or UE can calculate UE location based on the measurement results. The PRS may be either DL-PRS or SRS for positioning, among others.

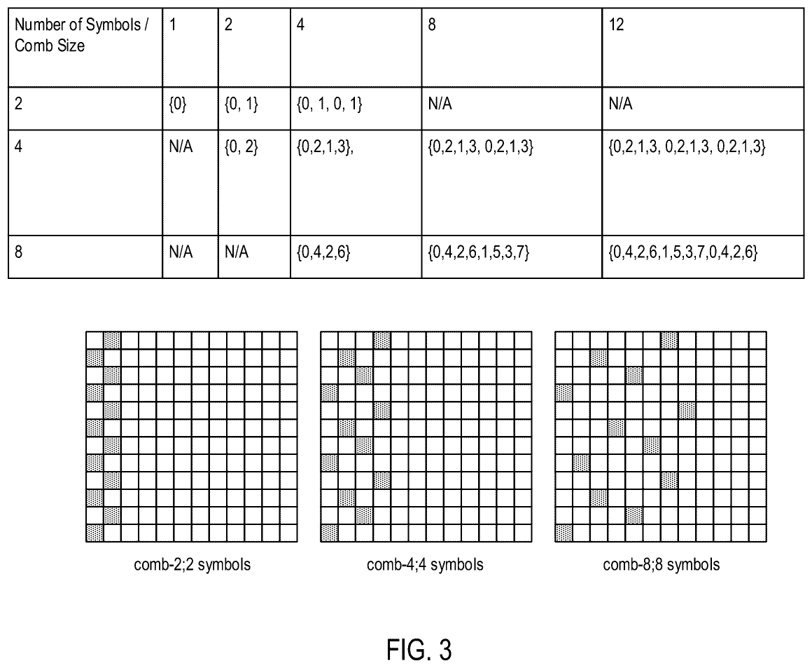

Referring now to FIG. 3, depicted is a diagram of resource mapping patterns for positioning reference signal (PRS). For DL or UL PRS, examples of the resource mapping patterns are shown. For timing based positioning methods which provide higher accuracy than angle based positioning methods, the positioning accuracy may highly rely on PRS bandwidth. However, for low cost UEs, the support maximum bandwidth may be limited. For example, RedCap UEs can only support 20 MHz in FRI and 100 MHz in FR2. Achieving high positioning accuracy and keep low cost for this kind of UEs may be unclear.

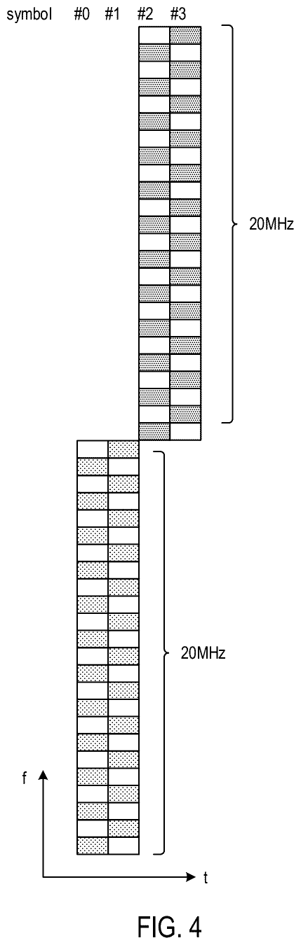

Referring now to FIG. 4, depicted is a block diagram of a frequency hopping of positioning sounding reference signal (SRS) within a single resource. For SRS, one method may be to introduce SRS frequency hopping within one SRS positioning resource as shown. For flexibility, the distance between two hops can be configured by network, (e.g., by gNB or LMF). In some scenarios, to make the channel inconstant, the distance between two hops in the frequency domain may be restricted (e.g., smaller than D where the unit of D is frequency resource or PRB or subcarrier or a frequency range). Timing error or random phase rotation between two frequency hops may be caused by UE RF re-tuning. This kind of timing error or phase rotation may be on a per symbol basis. For instance as shown, compared with symbol #0and #1, there may be a phase rotation adding in the channel response in symbol #2 and #3. The phase rotation may be generally constant across all REs or subcarriers within single symbol.

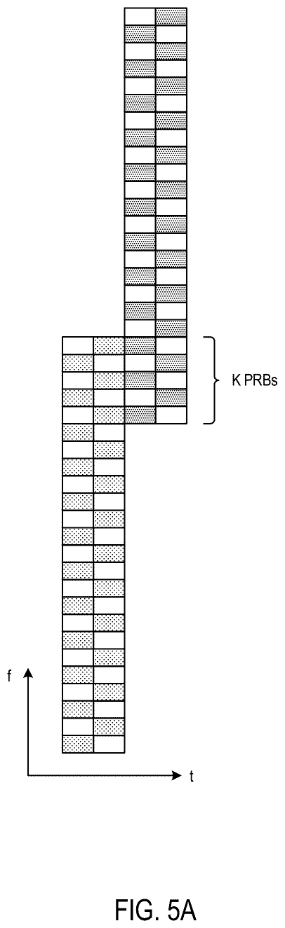

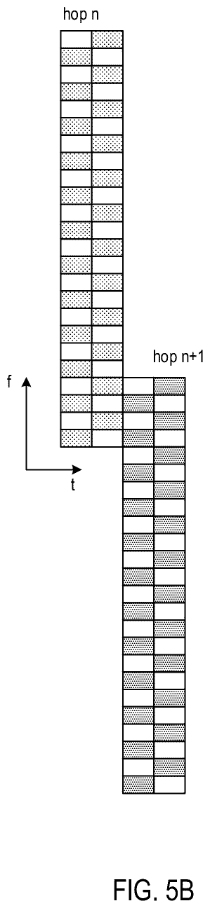

Referring now to FIG. 5A, depicted is a block diagram of a frequency hopping of positioning sounding reference signal (SRS) within a single resource with overlapping resource blocks in which a start frequency of a first frequency hop corresponds to an end frequency of a second frequency hop. One approach may be to introduce predefined or configured K overlapping frequency resources in adjacent frequency hops. The unit of K can be PRB, RE or a frequency range. K can be predefined in the specification or configured by network. The network may refer to a wireless communication node (e.g., base station or gNB, or LMF). Specifically, the start location xₙ₊₁^{start} in frequency domain of the frequency hop n+1 equals to the end location in frequency domain xₙ^{end} of the frequency hop n minus K or minus K and plus 1. In other words, xₙ₊₁^{start}=xₙ^{end}−K, or xₙ₊₁^{start}=xₙ^{end}−K+1 as shown. In the scenario, a total bandwidth of the first frequency hop and second frequency hop may be larger than a capability of the wireless communication device to support communication at a time or without frequency hopping.

To save signaling overhead, K value can be determined by some of other parameters, e.g. PRS bandwidth for one or more frequency hops, center frequency f0, the number of frequency hops, a subcarrier spacing (SCS), etc. For example, K=1 PRB if PRS bandwidth for each hop=10M, but K=2 PRB if PRS bandwidth for each hop=20 M. The larger bandwidth of each hop, the larger K value may be. That's because larger bandwidth PRS needs more overlapping resources for phase noise estimation. For example, K=2, the end or the last location in frequency domain of the frequency hop n is PRB 99, the bandwidth of each frequency hop is 100 PRB. Then, the start location xₙ₊₁^{start} in frequency domain of the frequency hop n+1 equals to xₙ₊₁^{start}=xₙ^{end}−K=99−2=97, or xₙ₊₁^{start}=xₙ^{end}−K+1=99−2+1=98.

Referring now to FIG. 5B, depicted is a block diagram of a frequency hopping of positioning sounding reference signal (SRS) within a single resource with overlapping resource blocks in which an end frequency of a first frequency hop corresponds to a start frequency of a second frequency hop. As shown, the end location xₙ₊₁^{end} in frequency domain of the frequency hop n+1 equals to the start location in frequency domain xₙ^{start} of the frequency hop n plus K or plus K−1 or plus K+1. In other words, xₙ₊₁^{end}=xₙ^{start}+K, or xₙ₊₁^{end}=xₙ^{start}+K−1 or xₙ₌₁^{end}=xₙ^{start}+K+1. For example, K=1, the start location in frequency domain of the frequency hop n is PRB 50, the start location xₙ₊₁^{end} in frequency domain of the frequency hop n+1 equals to xₙ₊₁=xₙ^{start}+K=50+1=51, or xₙ₊₁^{end}=xₙ^{start}+K−1=50+1−1=50, or xₙ₊₁^{end}=xₙ^{start}+K+1=50+1+1=52. Assuming xₙ₊₁^{end}=50 and the length of each frequency hop is 20 PRBs, then the start location of the frequency hop n+1 is 50−20+1=31st PRB. The PRB number can be counted in common resource block.

The network can indicate UE whether the end location of next adjacent frequency hop n+1 is lower or higher than the end location of next adjacent frequency hop n (e.g., to indicate UE whether it is pattern in FIGS. 5A or 5B) using higher-layer signaling.

Based on above solutions, there may be some overlapping in frequency domain in adjacent frequency hops. Then, receiver side can estimate phase rotation or timing difference of adjacent frequency hops and compensate the phase rotations. Further, the channel estimation results of adjacent frequency hops can be combined in frequency domain. This may be equivalent to a large bandwidth PRS measurement without requiring UE supporting of large bandwidth. Assuming PRSs in the first hop and the second hop are the first PRS and the second PRS respectively, other signals except PRS can be referred to as a third signal. In some examples, the third signals can include a physical uplink shared channel (PUSCH), physical downlink shared channel (PDSCH), channel state information reference signal (CSI-RS), physical uplink control channel (PUCCH), and physical random access channel (PRACH), among others, may not transmitted across multiple frequency hops. The third signal different from the first PRS and the second PRS may be associated with or confined within a frequency of one of the first PRS or the second PRS.

From UE side, UE has to report its capability to LMF or gNB for support of frequency hopping. UE can also report its capability to LMF or gNB for support of overlapping between two frequency hop. Even though frequency hopping is configured to UE (or TRP or gNB) for the sake of equivalent large bandwidth PRS transmission, reception, or measurement, sometimes a UE may not have to combine the measurement from multiple frequency hops. (e.g., in the scenarios when PRS configuration is broadcast for all UEs in a serving cell) but the UE's location requirement from accuracy perspective may not be high. In such case, UE or TRP or gNB may report a single hop index for the location measurement results, (e.g., in NR-DL-TDOA-SignalMeasurementInformation). In other words, in some embodiments, the wireless communication device or the wireless communication node may report multiple hop information for a location measurement result which is based on a combination of multiple-hop PRS. Furthermore, in some embodiments, the wireless communication device or the wireless communication node may report single hop information for a location measurement result which is based on a single-hop PRS.

### B. Non-Staggered Pattern in Overlapping Physical Resource Blocks (PRBs) in Adjacent Frequency Hops

In some scenarios, the above solutions may work well, such as in FR2 with phase noise impact or in the case when UE has high UE mobility. This may be because staggered pattern is used in the DL or UL PRS as shown in FIG. 3. In a subcarrier in frequency domain, PRS may only be present in some symbols, and the UE cannot estimate phase noise of adjacent OFDM symbols in one subcarrier.

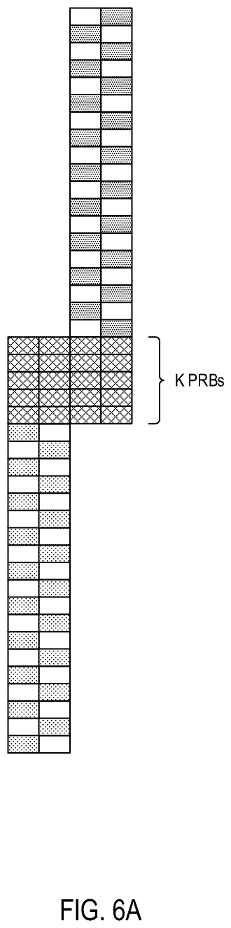

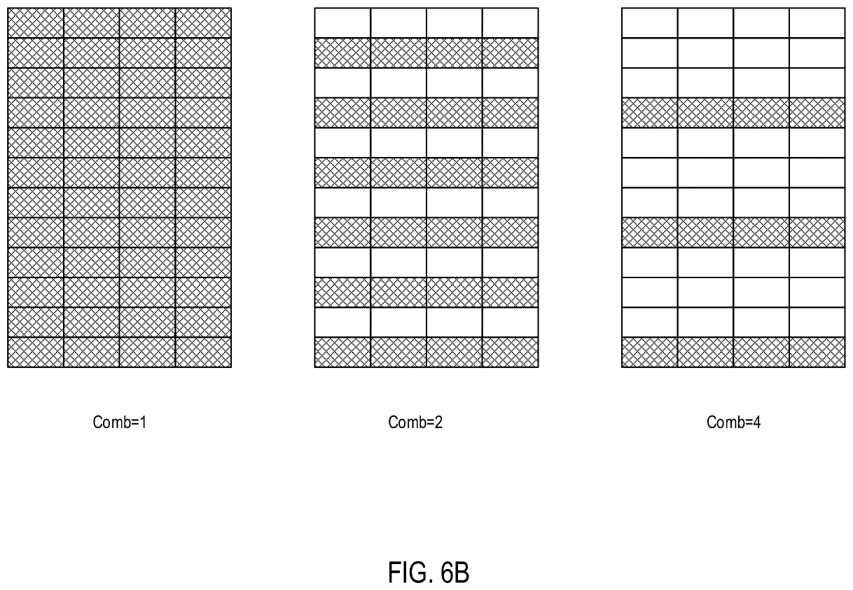

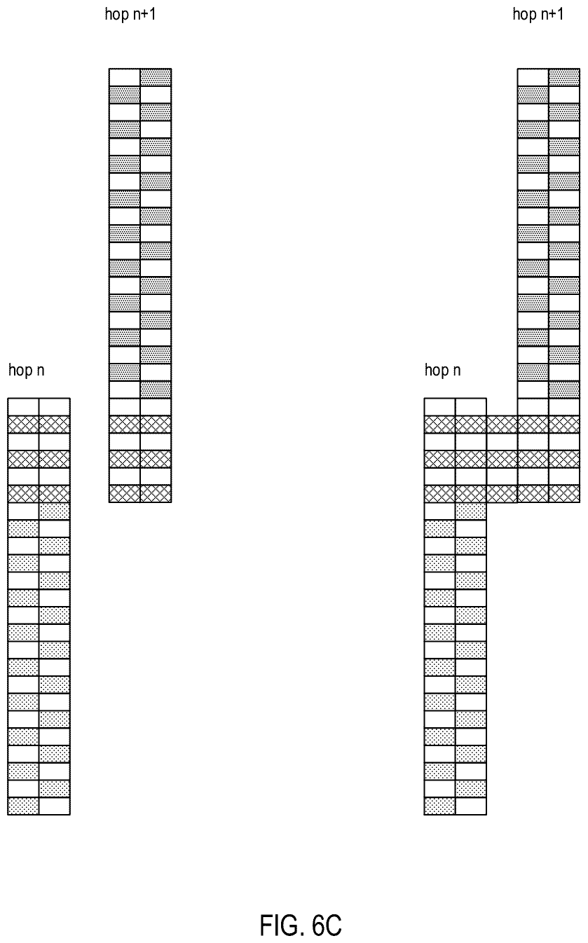

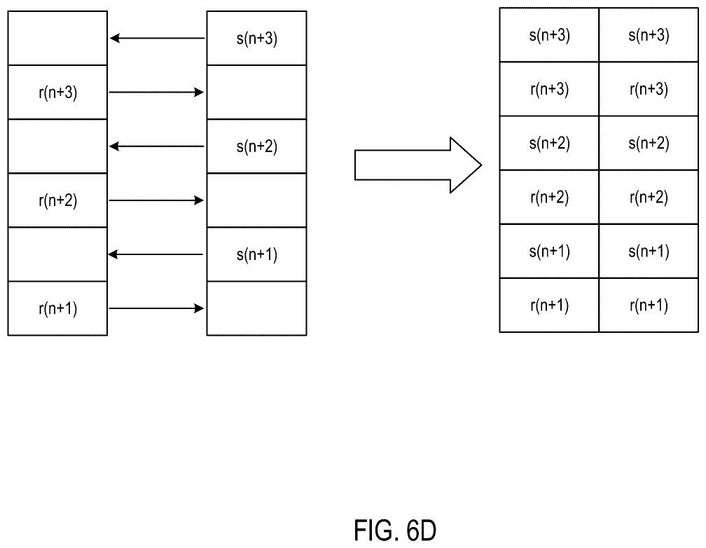

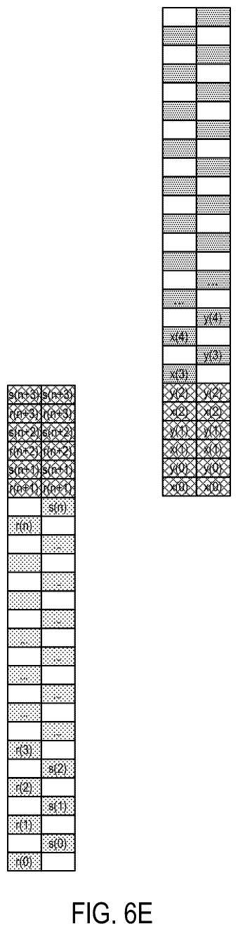

Referring now to FIG. 6A, depicted is a block diagram of a non-staggered pattern in overlapping physical resource blocks (PRBs) in adjacent frequency hops of positioning reference signals (PRS). One approach may be to use non-staggered pattern in the overlapping part as shown where two frequency hops overlapping in K frequency resources (e.g., K PRBs do not use staggered pattern). Specifically, in overlapping part, at least in one subcarrier, PRS may transmit in all symbols of the two adjacent hops. In K overlapping PRBs, PRS may transmitted in all subcarriers as shown. Then, receiver side can use the overlapping part to estimate accurate phase noise.

Referring now to FIG. 6B, depicted is a block diagram of a non-staggered pattern in overlapping physical resource blocks (PRBs) of various frequency densities. Furthermore, in overlapping part, the PRS can be predefined or configured in every combination (Comb) of subcarriers. In each subcarrier with PRS, PRS is transmitted in all symbols of adjacent hops. As shown i M=1, 2 and 4 in the depicted example. For M=2 and 4, power boosting gain can be achieved. In FIGS. 6A and 6B, the PRS patterns in non-overlapping and overlapping part may be different. In some embodiments, M value may be determined by at least one of: a bandwidth for the first frequency hop or the second frequency hop; a center frequency; a number of frequency hops; a subcarrier spacing; or a frequency density in one symbol of non-overlapping part, among others.

Referring now to FIG. 6C, depicted is a block diagram of a frequency hopping of positioning sounding reference signal (SRS) within a single resource with non-staggered pattern in the overlapping physical resource blocks (PRBs). In addition, as RedCap UE may only support a maximum 20/100 MHz bandwidth at a given time in FR1/FR2. The UE may have to operate RF re-tuning between two frequency hops. This may imply that UE is to have some switching gap between two frequency hops because of extra complexity from RF re-tuning. One example pattern with Comb=2 in overlapping PRBs is shown in the depicted example. The gap can be denoted as X symbols where X can be predefined or configured by network. X can depend on the subcarrier spacing (SCS) or UE capability.

In some scenarios, the PRS can be transmitted in every O orthogonal frequency division multiplexing (OFDM) symbols in the overlapping part, where O>1, e.g. O=2, 4. For most flexibility, the bandwidth of each frequency hop can be configured. In other words, different bandwidth may be configured for different frequency hops. Instead of configuring K value, the start location of each frequency hop can be configured independently. In such case, two frequency hops overlap may be allowed in the frequency domain.

### I. Sequence Design

For the overlapping part, the pattern may not be aligned with PRS anymore. One sequence design may be to make sequence values are the same between adjacent symbols of one frequency hop. Specifically, for each hop, in one symbol, the sequences may be generated based on the existing specification where the sequences are generated only on a subset resource element (REs), (e.g., on every C=2 REs from RE=0, 2, 4, etc.). In overlapping part, the sequence values for the remaining subset REs may be based on sequence values from the other symbol(s) in the same subcarrier. For example, in overlapping part, the sequence values for the remaining subset REs may be copied (the same as) from the other symbol(s) in the same subcarrier. In general, the sequence values of a first subset of resource elements for a first symbol in each frequency hop of an overlapping portion may be generated based at least on the sequence values of the first subset of resource elements for a second symbol. On the other hand, the sequence value of a second subset of resource elements for the second symbol in each frequency hop of an overlapping portion may be generated based at least on sequence value of the second subset of resource elements for the first symbol. The first subset and the second subset may correspond to different frequency offsets or comb offsets, such that the subsets are not mapped to different subcarriers.

Referring now to FIG. 6D, depicted is a block diagram of setting of sequence values in an overlapping portion of the physical resource blocks (PRBs) for positioning sounding reference signals (SRS) in adjacent frequency hops. As shown, for the first symbol in the first hop, sequences may be generated based on the existing specification where the sequences are generated only on a first set REs, (e.g., on every C=2 REs from even REs=0, 2, 4, . . . ). The corresponding sequence values are r(0), r(1), r(2) . . . r(n+3). For the second symbol in the first hop, sequences are generated based on the existing specification where the sequences are generated only on a first set REs, e.g. on every C=2 REs from odd RE=1, 3, 5, . . . , the corresponding sequence values are s(0), s(1), s(2) . . . s(n+3).

Referring now to FIG. 6E, depicted is a block diagram of a sequence design for an overlapping portion of the physical resource blocks (PRBs) for positioning sounding reference signals (SRS) in adjacent frequency hops. For the first symbol in the first hop on overlapping part, the sequence values on odd REs may be s(n+1), s(n+2), s(n+3). For the second symbol in the first hop on overlapping part, the sequence values may be on even REs are r(n+1), r(n+2), r(n+3). Likewise for the second hop. The similar solution can be used for other C values. C. Use of Phase Tracking Reference Signals or Different Types of Reference Signals in Overlapping Physical Resource Blocks (PRBs) in Adjacent Frequency Hops

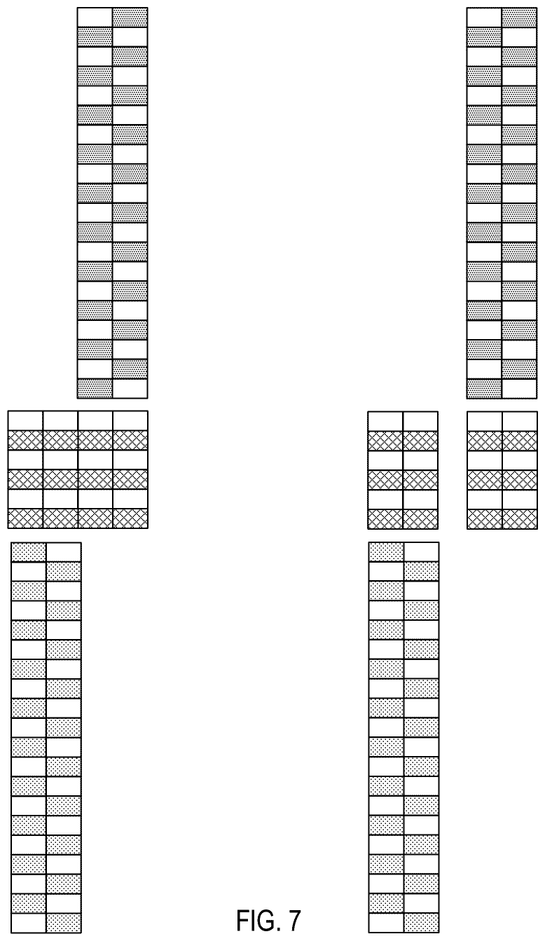

Referring now to FIG. 7, depicted is a block diagram of a frequency hopping of positioning sounding reference signal (SRS) within a single resource with overlapping resource blocks of a set frequency density and hopping gap, A phase tracking reference signal (PTRS) or another type of RS may be used instead of overlapping part. In other words, PTRS (or another type of RS may be is transmitted in the same set of subcarriers across adjacent frequency hops. Then, both PTRS (or another type of RS) and PRS may be transmitted simultaneously. In other words, PTRS can be configured without data transmission, and configured together with PRS.

The frequency location, bandwidth, and patterns such as FIG. 6B can be predefined or configured by network for the PTRS (or another type of RS). For example, PTRS (or another type of RS) for PRS may be predefined in the last or start K PRBs within PRS bandwidth or adjacent with PRS bandwidth. As shown in FIG. 6C, the shaded par may be PTRS, adjacent to PRS.

Another example is shown in FIG. 7 where PTRS (or another type of RS) is not adjacent with PRS. For sequence design, sequence values may be set in each subcarrier are the same between adjacent symbols of one frequency hop. Moreover, the sequence may be generated for the first symbol, and may be copied to the subsequent symbols. From UE side, UE may report its capability to LMF or gNB for support of PTRS (or another type of RS) for positioning.

### D. Linkage Between Multiple Resource Groups for Different Frequency Hops

In the above embodiments, multiple frequency hops may belong to one PRS resource. A linkage between multiple resource groups may be set up. Multiple resource groups may correspond to different frequency hops. The resource groups may include one or more of: a PRS resource, a PRS resource set, a PRS positioning frequency layer (PFL), a bandwidth part (BWP), or component carrier (CC) for serving cell.

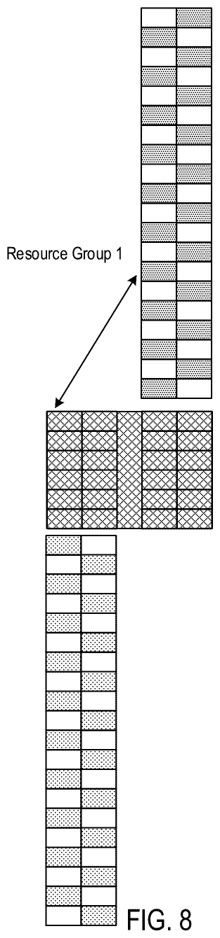

Referring now to FIG. 8, depicted is a block diagram of a linkage between two resource groups in positioning sounding reference signals in adjacent frequency hops. As shown, two PRS resources or resource sets or PFLs or BWPs or CCs may be linked for PRS configuration. At receiver side, UE can combine the linked resource groups to obtain a combined measurement result for the linked resource groups. The UE may combine the linked resource groups in frequency domain. The measurement may be based on the linked resource groups equivalent to a larger bandwidth measurement.

For linked resource groups, at least some of parameters may be the same to ensure receiver side can combine the multiple resource groups, such as: SCS; Comb size; TRP ID, or dl-PRS-ID; DL-PRS-ID-Info; nr-DL-PRS-ExpectedRSTD; nr-DL-PRS-ExpectedRSTD-Uncertainty; dl-PRS-PointA; cyclic prefix (CP) type; dl-PRS-Periodicity-and-ResourceSetSlotOffset; dl-PRS-ResourceRepetitionFactor; dl-PRS-SequenceID; Comb offset; dl-PRS-QCL-Info; and dl-PRS-ResourceSlotOffset, among others:

For linked resource groups, one resource group can be set or predefined as the reference. If some parameters from resource groups other than the reference are not indicated, the default values of those parameters can refer to the values of the reference resource group. Furthermore, PRS transmission from two linked resource groups can only be time division multiplexing (TDM) manner. Because of RF re-tuning, X-symbol gap may be added between adjacent PRS transmission from linked resource groups.

In one example, PRS resources within a PRS resource set may be divided into multiple PRS resource subsets. Resources in one subset may be linked by default, and may correspond to different frequency hops. Then, the UE (or gNB or TRP for UL measurement) can combine the linked resources to obtain a combined measurement result. After receiver side measures the linked PRS, the receive side may report the measurement results with one or multiple indices of lined PRS resources for one measurement. One measurement can be a measurement element or additional measurement in which one PRS resource ID is reported. Even though frequency hopping is configured to UE (or TRP or gNB) for the sake of equivalent large bandwidth PRS transmission, reception, or measurement, sometimes the UE may not have to combine the measurement from multiple frequency hop. For example, the UE may not combine, when PRS configuration is broadcast for all UEs in a serving cell but the UE's location requirement from accuracy perspective is not high. In such case, UE may report one PRS resource ID. If UE uses the multiple PRS resources for measurement and combine the results, then UE may report IDs of multiple linked PRS resources or may report some information associated with multiple linked PRS resources.

In another example, multiple PRS resource sets may be linked, and may correspond to different frequency hops. Then, UE (or gNB or TRP for UL measurement) can combine the linked resource sets to obtain a combined measurement result. In two linked resource sets, resources may be one-to-one linked. After receiver side measures the linked PRS, the receiver side may report the measurement results with one or multiple indices of linked PRS resource sets for one measurement. One measurement can be a measurement element or additional measurement in which only one PRS resource ID is reported. Even though frequency hopping is configured to UE (or TRP or gNB) for the sake of equivalent large bandwidth PRS transmission, reception, or measurement, sometimes a UE may not have to combine the measurement from multiple frequency hops. For example, the UE may not combine when PRS configuration is broadcast for all UEs in a serving cell but the UE's location requirement from accuracy perspective is not high. In such case, UE may report one PRS resource set ID. If UE uses the multiple PRS resource sets for measurement and combine the results, then UE may report IDs of multiple linked PRS resource sets. It may also be possible to report one or multiple indices of PRS resources of the linked resource sets for one measurement.

In another example, multiple bandwidth part (BWP), component carrier (CC), or a positioning frequency layer (PFL) may be linked, and may correspond to different frequency hops. Then, UE (or gNB or TRP for UL measurement) can combine the linked resource sets to get a combined measurement result. In two linked resources (e.g., BWP, CC, or PFL), PRS resources or resource sets may be one-to-one linked. After receiver side measures the linked PRS, the receiver side may report the measurement results with one or multiple indices of linked BWP, CC, or PFL for one measurement. If UE only reports one BWP, CC, or PFL ID, it may imply the UE only use single frequency hop measurement and does not combine the measurement from multiple frequency hops. If UE reports more than one linked BWP, CC, or PFL ID, it may imply that the UE uses multiple frequency hop measurement and combine the measurement from multiple frequency hops for the sake of higher positioning accuracy. In some cases, only PRS may be configured in multiple linked BWP, CC, or PFL or frequency hops in terms of frequency domain. Other signals may not be linked and only configured within one or some of those linked BWP, CC, or PFL, or frequency hops.

E. Reporting of UE Capability with Respect to Positioning Measurement

For a UE without PRS frequency hopping to support positioning measurement in a frequency layer fin a band b, UE may report UE capabilities to the network (e.g., LMF or gNB). The UE capabilities per band may comprise one or more of following. The capability may include a maximum bandwidth B which is supported by UE. This parameter can be reported separately for FR1 band and FR2 band. For example, maximum 80 MHz is supported and reported by UE for a FR1 band b, and 200 MHz is supported and reported by UE for a FR2 band b. The capability may also include DL PRS buffering capability of type 1 or type 2. Type 1 may be sub-slot or symbol level buffering. Type 2 may be slot level buffering.

In addition, the capability may include a combination of (N, T) values. N may be a duration of DL PRS symbols in ms processed every T ms for a given maximum bandwidth B in MHz supported by the UE. Duration of DL PRS symbols N in units of ms a UE can process every T ms, assuming maximum DL PRS bandwidth in MHz, that is supported and reported by UE. Example values for T may include {8, 16, 20, 30, 40, 80, 160, 320, 640, 1280} ms. Example values for N may include {0.125, 0.25, 0.5, 1, 2, 4, 6, 8, 12, 16, 20, 25, 30, 32, 35, 40, 45, 50} ms. The capability may also include a maximum number of DL PRS resources R that UE can process in a slot. R may be different for different subcarrier spacing (SCS), and also different for a FR1 band or FR2 band

The UE may reports its capability signaling as described above. On the other hand, LMF may configure the positioning reference signal (RS) (PRS). For the purpose of DL PRS processing capability, the duration K ms of DL PRS symbols within P ms window corresponding to the maximum PRS periodicity in a positioning frequency layer, may be calculated using the following: Type 1 duration calculation with UE symbol level buffering capability may be:

$$K = {\sum }_{s ∈ S} {K}_{s}$$

$${K}_{s} = {T}_{s}^{e n d} - {T}_{s}^{start}$$

In addition, Type 2 duration calculation with UE slot level buffering capability may be:

$$K = \frac{1}{{2}^{μ}} \vert S \vert$$

where S is the set of slots based on the numerology of the DL PRS of a serving cell within the P msec window in the positioning frequency layer that contains potential DL PRS resources. For Type 1, [Tₛ^{start}, Tₛ^{end}] may be the smallest interval in ms within slot s corresponding to an integer number of OFDM symbols based on the numerology of the DL PRS of a serving cell that covers the union of the potential PRS symbols and may determine the PRS symbol occupancy within slot s. For Type 2, μ may be the numerology of the DL PRS.

(K, P) may imply that the UE is to process PRS of K ms duration within a window with P ms period, where K and P depends on the PRS configuration. Assuming P is the same as UE capability T, if K<=UE capability N, that is UE can process all K ms duration of PRS. However, if K>N, UE may not be able to process K ms PRS within window P. For example, K=2N, that means UE may process all K ms PRS within 2P window since the configured PRS measurement is beyond UE capability. All above design may be for the case without PRS frequency hopping. For a UE to support PRS frequency hopping, more UE complexity may be used because of RF re-tuning and combination of measurement in multiple frequency hops.

### I. Issue Regarding UE Capability Report for DL

For UE support DL PRS frequency hopping, UE may report Fₕ value which is the maximum number of support frequency hops. For each hop, the support maximum PRS bandwidth can refer to the existing UE capability report. For instance, if UE reports that the support maximum PRS bandwidth is 20 MHz which is for the case without PRS frequency hopping, and UE reports the support maximum number of frequency hops are 4, then network may configure maximum 4 frequency hops to achieve measurement results which is equivalent to the result based on about 80 MHz PRS bandwidth.

In some embodiments, for PRS frequency hopping, UE may additionally report the combination values of (Nₕ, Tₕ), where Nₕ is a duration of DL PRS symbols in ms processed every Tₕ ms for a given maximum bandwidth B and a number of support frequency hops F. UE may also report an additional Rₕ wherein Rₕ is maximum number of DL PRS resources that UE can process in a slot in case PRS frequency hopping measurement is enabled. At least one of the following restrictions may be satisfied:

$$\frac{{N}_{h}}{{T}_{h}} < \frac{N}{T} \qquad ( 1 )$$

$${R}_{h} < R \qquad ( 2 )$$

In some embodiments, at least one of Nₕ, Tₕ, and Rₕ may be omitted for the case of PRS frequency hopping, and the maximum support values for these parameters can be determined by some of N, T, R and Fₕ. For instance, Rn may be determined by R and Fₕ, e.g.

$${R}_{h} = floor ( \frac{R}{{F}_{h}} ) or {R}_{h} = ceil ( \frac{R}{{F}_{h}} ) .$$

### II. Issue Regarding Processing Calculation

For the cases without PRS frequency hopping, for the purpose of DL PRS

processing capability, the duration K msec of DL PRS symbols within P msec window, may be calculated using the following. Type 1 duration calculation with UE symbol level buffering may be:

$$K = {\sum }_{s ∈ S} {K}_{s}$$

$${K}_{s} = {T}_{s}^{e n d} - {T}_{s}^{start}$$

Type 2 duration calculation with UE slot level buffering capability

$$K = \frac{1}{{2}^{μ}} \vert S \vert$$

S is the set of slots based on the numerology of the DL PRS of a serving cell within the P msec window in the positioning frequency layer that contains potential DL PRS resources considering the actual nr-DL-PRS-ExpectedRSTD, nr-DL-PRS-ExpectedRSTD-Uncertainty provided for each pair of DL PRS Resource Sets.

For Type 1, [Tₛ^{start}, Tₛ^{end}] may be the smallest interval in msec within slot s corresponding to an integer number of OFDM symbols based on the numerology of the DL PRS of a serving cell that covers the union of the potential PRS symbols and may determine the PRS symbol occupancy within slot s, where the interval [Tₛ^{start}, Tₛ^{end}] considers the actual nr-DL-PRS-ExpectedRSTD, nr-DL-PRS-ExpectedRSTD-Uncertainty provided for each pair of DL PRS resource sets (target and reference). For Type 2, μ may be the numerology of the DL PRS, and |S| is the cardinality of the set S.

For the cases of PRS frequency hopping, to relax UE implementation complexity, the X symbol gap between adjacent hops may be also counted to calculate the K value. That is, [Tₛ^{start}, Tₛ^{end}] also may include the OFDM symbols corresponding X symbol gap. Also, S slots may include X symbol gap.

In some embodiments, K value may rely on whether PRS frequency hopping is enabled or relies on the configured number of PRS frequency hops or rely on the total bandwidth of multiple frequency hops. For instance, an additional Kₑₓₜᵣₐ may be added to the K value if PRS frequency hopping is enabled.

Whether PRS frequency hopping is enabled may depend on the techiques mentioned in above including frequency hopping within one resource or linked between multiple resource groups.

III. Issue with UE Capability Report for UL

For UL UE capability report, on top of the existing UE capability for cases without UL PRS frequency hopping, UE may additionally report the maximum support number of UL PRS resources or resource sets for SRS frequency hopping. In some embodiments, the maximum support number of UL PRS resources or resource sets for SRS frequency hopping may rely on the existing UE capability for cases without UL PRS frequency hopping and whether hopping is enabled (or and Fₕ).

### F. Radio Resource Control (RRC) Modes in Relation to Frequency Hopping

For power saving, PRS frequency hopping can be only used for UE in RRC_CONNECTED state. When PRS frequency hopping is enabled, but UE is in RRC_INACTIVE or idle state, UE may not perform PRS measurement for multiple PRS frequency hops for power saving and low UE complexity. UE may measure or report measurement result based on one PRS frequency hop.

In such case, UE behavior can be one of the following. The UE behavior may be predefined or configured by network with one default PRS frequency hop which is used for RRC_INACTIVE or idle state. The default hop can be the one within the active BWP for data. The UE behavior may be predefined or configured by network to prioritize multiple PRS frequency hops. UE can selectively measure the frequency hops based on the prioritization

Even when PRS frequency hopping is enabled, UE can still fall back to single hop PRS measurement not only for RRC_INACTIVE or idle state, but also for some other cases (e.g., the configured PRS resources are beyond than that UE can support). The above prioritization can still be used in the cases. In some embodiments, the UE may prioritize or deprioritize the PRS resources, resource sets or PFL or CC or BWP with frequency hopping over that without hopping.

In some embodiments, UE can report whether support PRS frequency hopping or the maximum support number of frequency hops independently for RRC_CONNECTED and RRC_INACTIVE state respectively. In some embodiments, LMF can recommend UE whether PRS measurement is based on frequency hopping or based on single frequency hop for the case when UE is in RRC_INACTIVE state. The LMF may not be aware of UE's RRC state.

In this manner, predefined or configured K overlapping frequency resources may be introduced in adjacent frequency hops. The unit of K can be PRB, RE, or a frequency range. K can be predefined in the specification or configured by network (e.g., by a base station or gNB, or LMF using higher layer signaling such as RRC). For example, the start location xₙ₊₁^{start} in frequency domain of the frequency hop n+1 may equal to the end location in frequency domain xₙ^{end} of the frequency hop n minus K or minus K and plus 1. In other words, xₙ₊₁^{start}=xₙ^{end}−K, or xₙ₊₁^{start}=xₙ^{end}−K+1. From UE side, UE may report its capability to LMF or gNB for support of frequency hopping. UE can also report its capability to LMF or gNB for support of overlapping between two frequency hop. The UE or TRP or gNB may also report hop index for the location measurement results.

In overlapping part, at least in one subcarrier, PRS is transmit in all symbols of the two adjacent hops. In K overlapping PRBs, PRS is transmitted in all subcarriers. The UE may add some switching gap between two frequency hops to account for extra complexity from RF re-tuning. One sequence design may be to make sequence values are the same between adjacent symbols of one frequency hop. In some embodiments, a PTRS (phase tracking reference signal) or another type of RS instead of overlapping part may be used. In some embodiments, the linkage between multiple resource groups may be set up. Multiple resource groups correspond to different frequency hops. For UE support DL PRS frequency hopping, UE may report Fₕ value which is the maximum number of support frequency hops.

G. Process for Positioning Using Reference Signals with Overlapping Resources

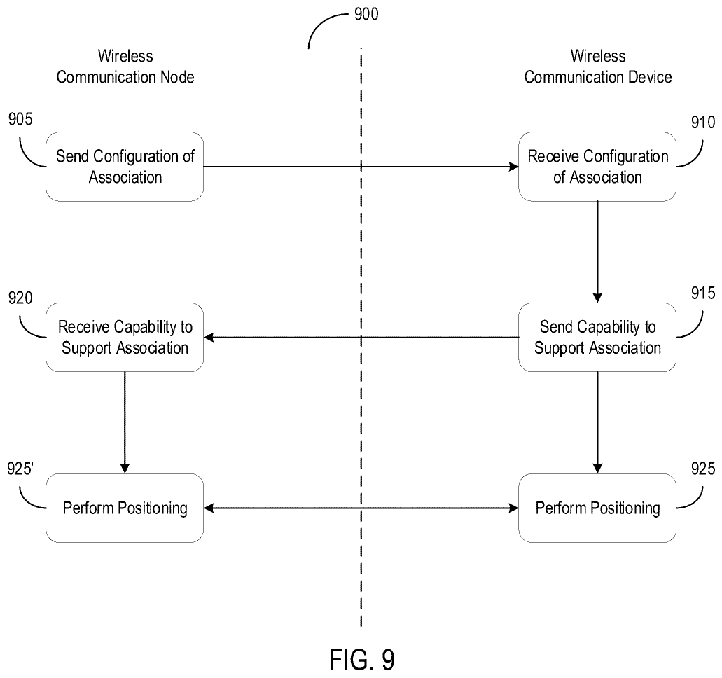

Referring now to FIG. 9, depicted is a flow diagram of a method 900 of positioning of wireless communication devices. The method 900 may be implemented using or performed by any of the components detailed above, such as the UE 104 or 204 and BS 102 or 202, among others. In overview, a wireless communication node may send a configuration of an association to a wireless communication device (905). The wireless communication device may receive the configuration of the association from the wireless communication node (910). The wireless communication device may send a capability to support the association to the wireless communication node (915). The wireless communication node may receive the capability to support the association from the wireless communication device (920). The wireless communication device and the wireless communication node may perform positioning measurement (925 and 925′).

In further detail, a wireless communication node (e.g., the BS 102, 202, gNB, or location management function (LMF) may provide, transmit, or otherwise send a configuration of an association to a wireless communication device (e.g., UE 104 or 204) (905). The association may be between a first reference signal (e.g., a positioning sounding reference signal (PRS)) at a first frequency hop and a second reference signal (e.g., a PRS) at a second frequency hop to be transmitted by the wireless communication device. In some embodiments, the wireless communication node may send the configuration via a higher layer signaling (e.g., radio resource control (RRC)) to the wireless communication device. The first reference signal and the second reference signal may be used by the wireless communication device in performing positioning measurements of the wireless communication device.

The wireless communication node may determine the association based on a number of factors. In some embodiments, the association between the first reference signal and the second reference signal may be specified, identified, or otherwise identified as a frequency overlap between the first reference signal and the second reference signal. In some embodiments, the frequency overlap between the first reference signal and the second reference signal may be determined (e.g., by the wireless communication device as part of the association) based on one or more of: a bandwidth for the first frequency hop; a bandwidth for the second frequency hop; a center frequency of the first frequency hop or the second frequency hop; a number of frequency hops; or a subcarrier spacing (SCS), among others.

The frequency overlap between the first reference signal and the second reference signal may be defined in terms of a start and ending frequencies of the first reference signal and the second reference signal. In some embodiments, a start frequency of the second reference signal may correspond to an end frequency of the first reference signal shifted by the frequency overlap. In some embodiments, an end frequency of the second reference signal may correspond to a start frequency of the first reference signal shifted by the frequency overlap. In some embodiments, a start frequency of the first frequency hop and a start frequency of the second frequency hop may be independently configurable. Conversely, an end frequency of the first frequency hop and an end frequency of the second frequency hop may be independently configurable. The total bandwidth of the first frequency hop and the second frequency hop may be larger than a capability of the wireless communication device to support communication at a single instance of time.

In some embodiments, an overlapping portion between the first reference signal and the second reference signal as defined by the association may include a set of resource blocks (e.g., physical resource blocks (PRBs)) in a non-staggered pattern. The overlapping portion may correspond to a part of the first reference signal and a part of the second reference signal along the same frequencies at different times. In addition, a non-overlapping portion of the first reference signal and the second reference signal may be in a staggered pattern. The non-overlapping portion may correspond to a part of the first reference signal and a part of the second reference signal along different frequencies.

In the non-staggered pattern, the first reference signal and the second reference signal among the set of resource blocks may be located at one of each M subcarriers, where M is an integer value greater than or equal to 1. The value M may be determined (e.g., by the wireless communication device as part of the association) based on one or more of: a bandwidth of the first frequency hop; a bandwidth of the second frequency hop; a center frequency for the first frequency hop or the second frequency hop; a subcarrier spacing (SCS); or a frequency density of at least one symbol in the non-overlapping portion. In some embodiments, the overlapping portion between the first reference signal and the second reference signal may include at least one switching gap. The switching gap may correspond to a lack of any transmitted resources between the first reference signal and the second reference signal along the time domain. A size of the switching gap may be dependent on the subcarrier spacing or a capability of the wireless communication device to support the association.

In addition, the values in symbols in each of the first frequency hop and the second frequency hop in the overlapping portion may be dependent on each other. In some embodiments, at least some adjacent symbols in each of the first frequency hop and the second frequency hop in the overlapping portion may have the same sequence value. In some embodiments, the sequence values of a first subset of resource elements for a first symbol may be determined or generated based on the sequence values of the first subset of resource elements for a second symbol. The first subset of resource elements may be in each frequency hop in the overlapping portion. In some embodiments, the sequence value of a second subset of resource elements for the second symbol may be determined or generated based on the sequence value of the second subset of resource elements of the first symbol. The second subset of resource elements may be in each frequency hop in the overlapping portion. Both the first subset of resource elements and the second subset of resource elements may not be overlapping in the frequency domain.

The overlapping portion of first reference signal and the second reference signal may be of a different type of reference signal from the non-overlapping portion at least in part. In some embodiments, an overlapping portion between the first reference signal and the second reference signal defined by the frequency overlap may be of a first type of reference signal. The first type of reference signal may be different from a second type of reference signal in a remaining portion of at least one of the first reference signal or the second reference signal. For example, the first type or second type of reference signal may be a phase tracking reference signal (PTRS). In some embodiments, both the first type of reference signal and the second type of reference signal may be for positioning measurements.

Furthermore, the first reference signal and the second reference signal may correspond to different resource groups. In some embodiments, the configuration of the association may identify or include at least one linkage between two or more resource groups. The two resource groups may correspond to the first reference signal and the second reference signal respectively. Each resource group may be or may include one or more of: a positioning reference signal (PRS) resource; a PRS resource set; a PRS positioning frequency layer (PFL); a bandwidth part (BWP), or a component carrier (CC) of a serving cell, among others. In some embodiments, a third signal from the resource groups may be different the first reference signal and the second reference signal. In addition, the third signal may be associated with a frequency on one of the first reference signal or the second reference signal.

The configuration may include other specifications for the specification between the first reference signal and the second reference signal, such as those in relation to radio resource control (RRC) inactive or idle state. In some embodiments, the configuration prioritization of at least one of the first frequency hop or the second frequency hop for measurement in an RRC inactive state or idle state. The wireless communication device may in turn retrieve, identify, or otherwise receive the configuration of the association from the wireless communication node (910).

The wireless communication device may communicate, transmit, or otherwise send at least one capability of the wireless communication device to support the association to the wireless communication node (915). With receipt of the configuration from the wireless communication node, the wireless communication device may determine or identify the capability of the wireless communication device to support the association between the first frequency hop and the second frequency hop. In some embodiments, the capability of the wireless communication device may be to support the frequency overlap between the first reference signal and the second reference signal. The wireless communication device may determine or identify the capability to support the frequency overlap between the first reference signal and the second reference signal.

The capability of the wireless communication device may be dependent on a number of factors associated with the ability to support frequency hopping and resources. In some embodiments, the capability of the wireless communication device may identify or include a maximum number of Fₕ of supported frequency hops or linked resource groups. In some embodiments, the capability of the wireless communication device may identify or include a duration Nₕ of reference signal symbols to processed over a time period Tₕ for a bandwidth Bₕ or a number F of supported frequency hops or linked resource groups. In some embodiments, the capability of the wireless communication device may identify or include a maximum number of reference signal resources Rₕ processed in a slot for a frequency hopping measurement.

Continuing on, in some embodiments, the capability of the wireless communication device may identify or include a duration N of PRS symbols to processed over a time period T for a bandwidth B when no frequency hopping is enabled. Using these definitions, at least one of the following may be satisfied:

$$\frac{{N}_{h}}{{T}_{h}} < \frac{N}{T} , or \qquad ( 1 )$$

$${R}_{h} < R . \qquad ( 2 )$$

In some embodiments, the wireless communication device may calculate, identify, or determine Nₕ, Tₕ, and Rₕ based at least on one of R, N, T and F.

The capability of the wireless communication device to support the association may be determined by the wireless communication device for a downlink (DL) reference signal (e.g., a positioning reference signal (PRS)) purposes. In some embodiments, for the purpose of DL reference signal capability, the duration K of the DL reference signal symbols may include a switching gap between the first reference signal and the second reference signal. In some embodiments, for the purpose of DL reference signal capability, the duration K of DL reference signal symbols may be determined based on one or more of: an enablement of reference signal frequency hopping; a number of reference signal frequency hops; or the total bandwidth of the first frequency hop and the second frequency hop, among others.

The capability of the wireless communication device may identify or include any number of other characteristics or factors. In some embodiments, the capability of the wireless communication device may identify or include the first type of reference signal or the second type of reference signal in the overlapping portion. In some embodiments, the capability of the wireless communication device may identify or include one or more of: a support of frequency hopping or a maximum number of supported frequency hops for a RRC connected state. In some embodiments, the capability of the wireless communication device may identify or include one or more of: a support of frequency hopping or a maximum number of supported frequency hops for a RRC inactive state. The wireless communication node may retrieve, identify, or otherwise receive the capability to support the association from the wireless communication device (920).

The wireless communication device and the wireless communication node may perform positioning measurement (925 and 925′). In performing the positioning measurement, the wireless communication device may broadcast, send, or otherwise transmit the first reference signal and the second reference signal in accordance with the configuration of association. By transmitting, the wireless communication device and the wireless communication node may determine or generate a measurement result. The measurement result may identify or include a position of the wireless communication device in relation to the wireless communication node, and vice-versa.

In some embodiments, the measurement result may be determined based at least on a combination of the two or more resource groups corresponding to the first reference signal and the second reference signal. In some embodiments, the measurement result may identify or include information of one or more resources in the linked resource groups. The information of at least one resource may correspond or refer to the measure result based on a single frequency hop reference signal. In some embodiments, a single measurement report may be based on one of the first reference signal or the second reference signal in an RRC inactive state or idle state. In some embodiments, the wireless communication device or the wireless communication node may communicate information for a location measurement result. The information may identify or include hop information (e.g., one or more hop indices) for the location measurement result.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
receiving, by a wireless communication device from a wireless communication node, a configuration of an association between a first positioning reference signal (PRS) at a first frequency hop in a first time and a second PRS at a second frequency hop in a second time; and
communicating, by the wireless communication device with the wireless communication node, a capability of the wireless communication device to support the association between the first frequency hop and the second frequency hop,
wherein a total bandwidth of the first frequency hop and second frequency hop is larger than a capability of the wireless communication device to support communication at a time.

2. The method of claim 1, wherein the association between the first PRS and the second PRS is defined as a frequency overlap between the first PRS and the second PRS.

3. The method of claim 2, wherein the frequency overlap between the first PRS and the second PRS is determined based at least on one of: a bandwidth for the first frequency hop or the second frequency hop; a center frequency; a number of frequency hops; or a subcarrier spacing.

4. The method of claim 1, wherein the wireless communication device or the wireless communication node reports one or more hop information for a location measurement result.

5. The method of claim 2, wherein an overlapping portion between the first PRS and the second PRS comprises at least one switching gap, wherein a size of the switching gap is dependent on the capability of the wireless communication device.

6. The method of claim 1, wherein both a first type of the first PRS and a second type of the second PRS are for positioning.

7. The method of claim 5, wherein a capability of the wireless communication device includes a first type of PRS in the overlapping portion.

8. The method of claim 1, wherein the capability of the wireless communication device further comprises a maximum number Fₕ of supported frequency hops.

9. The method of claim 1, wherein the capability of the wireless communication device further comprises a duration Nₕ of reference signal symbols to processed over a time period Tₕ for a bandwidth Bₕ or a number F of supported frequency hops.

10. The method of claim 1, wherein the capability of the wireless communication device further comprises a maximum number of reference signal resources Rh processed in a slot for a frequency hopping measurement.

11. The method of claim 1, wherein for the purpose of DL PRS processing capability, the duration K of DL PRS symbols includes a switching gap between the first PRS and the second PRS.

12. The method of claim 1, wherein for the purpose of DL PRS processing capability, the duration K of DL PRS symbols is determined based on at least one of: enablement of reference signal frequency hopping, a number of reference signal frequency hops, or the total bandwidth of the first frequency hop and the second frequency hop.

13. The method of claim 1, wherein a single measurement report is based on one of the first PRS or the second PRS.

14. The method of claim 1, wherein the capability of the wireless communication device further comprises at least one of support of frequency hopping or a maximum number of supported frequency hops for RRC connected state and at least one of support of frequency hopping or maximum number of supported frequency hops for RRC inactive state.

15. A wireless communication device, comprising:
at least one processor configured to:
receive, via a transceiver from a wireless communication node, a configuration of an association between a first positioning reference signal (PRS) at a first frequency hop in a first time and a second PRS at a second frequency hop in a second time; and
communicate, via the transceiver with the wireless communication node, a capability of the wireless communication device to support the association between the first frequency hop and the second frequency hop,
wherein a total bandwidth of the first frequency hop and second frequency hop is larger than a capability of the wireless communication device to support communication at a time.

16. A method comprising:
sending, by a wireless communication node to a wireless communication device, a configuration of an association between a first positioning reference signal (PRS) at a first frequency hop and a second PRS at a second frequency hop to be transmitted by the wireless communication device; and
receiving, by the wireless communication node, from the wireless communication node, a capability of the wireless communication device to support the association between the first frequency hop and the second frequency hop,
wherein a total bandwidth of the first frequency hop and second frequency hop is larger than a capability of the wireless communication device to support communication at a time.

17. A wireless communication node, comprising:
at least one processor configured to:
send, via a transceiver to a wireless communication device, a configuration of an association between a first positioning reference signal (PRS) at a first frequency hop and a second PRS at a second frequency hop to be transmitted by the wireless communication device; and
receive, via the transceiver from the wireless communication node, a capability of the wireless communication device to support the association between the first frequency hop and the second frequency hop,
wherein a total bandwidth of the first frequency hop and second frequency hop is larger than a capability of the wireless communication device to support communication at a time.
